(19) United States
(12) Patent Application Publication
(10) Pub. No.: US 2018/0110050 A1
(43) Pub. Date: Apr. 19, 2018

(54) RADIO FRAME TRANSMISSION METHOD AND APPARATUS

(71) Applicant: Huawei Technologies Co., Ltd., Shenzhen (CN)

(72) Inventors: Jin LIU, Shanghai (CN); Ye WU, Shanghai (CN); Dageng CHEN, Shanghai (CN)

(73) Assignee: HUAWEI TECHNOLOGIES CO., LTD., Shenzhen (CN)

(21) Appl. No.: 15/821,895

(22) Filed: Nov. 24, 2017

Related U.S. Application Data
(63) Continuation of application No. PCT/CN2015/079720, filed on May 25, 2015.

(51) Int. Cl. H04W 72/04; H04L 5/00

(52) U.S. Cl. CPC H04W 72/0446; H04L 5/0055

(57) ABSTRACT

Implementation manners of the present disclosure disclose a radio frame transmission method, including: generating a radio frame, where the radio frame includes at least one first subframe, the at least one first subframe includes a downlink transmission field and an uplink transmission field, the downlink transmission field is used to carry a downlink signal, the uplink transmission field is used to carry an uplink signal, the downlink transmission field includes N_{DL} symbols, the uplink transmission field includes N_{UL} symbols, and a sum of N_{DL} and N_{UL} is less than or equal to a quantity of all symbols included in the first subframe; and sending the radio frame to a receive end, so that the receive end transmits a downlink signal according to the downlink transmission field and transmits an uplink signal according to the uplink transmission field.

### CROSS-REFERENCE TO RELATED APPLICATIONS

This application is a continuation of International Application No. PCT/CN2015/079720, filed on May 25, 2015, the disclosure of which is hereby incorporated by reference in its entirety.

### TECHNICAL FIELD

The present disclosure relates to the field of mobile communications, and in particular, to a radio frame transmission method and apparatus.

### BACKGROUND

With an increasing demand for a mobile communications service, a future 5th generation mobile communications (5G) system imposes a demanding requirement on a communication delay, and a subframe structure in an existing 4th generation mobile communications (4G) system cannot satisfy the requirement of the 5G system for a short delay.

### SUMMARY

Implementation manners of the present disclosure disclose a radio frame transmission method, so as to shorten time for feeding back an uplink signal, and reduce a system delay.

According to a first aspect, an implementation manner of the present disclosure puts forward a radio frame transmission method, including:

generating a radio frame, where the radio frame includes at least one first subframe, the at least one first subframe includes a downlink transmission field, a guard period, and an uplink transmission field, the downlink transmission field is used to carry a downlink signal, the uplink transmission field is used to carry an uplink signal, the guard period is used to extend duration in which a receive end is switched from the downlink transmission field to the uplink transmission field, the downlink transmission field includes N_{DL} symbols, the uplink transmission field includes N_{UL} symbols, N_{DL} and N_{UL} are integers greater than or equal to 0 and are not 0 at the same time, and a sum of N_{DL} and N_{UL} is less than or equal to a quantity of all symbols included in the first subframe; and

sending the radio frame to the receive end, so that the receive end transmits a downlink signal according to the downlink transmission field and transmits an uplink signal according to the uplink transmission field.

In a first possible implementation manner of the first aspect, the downlink signal includes one or more of a downlink control signal, a downlink data signal, or a downlink reference signal.

In a second possible implementation manner of the first aspect, the uplink signal includes one or more of an uplink control signal, an uplink data signal, or an uplink reference signal.

In a third possible implementation manner of the first aspect, the uplink signal is an acknowledgment character ACK/NACK or an uplink scheduling request.

With reference to the third possible implementation manner of the first aspect, in a fourth possible implementation manner of the first aspect, the acknowledgment character ACK/NACK is used to acknowledge data of a frame prior to the radio frame.

With reference to the third possible implementation manner of the first aspect, in a fifth possible implementation manner of the first aspect, the acknowledgment character ACK/NACK is used to acknowledge data of the fourth forward subframe of the first subframe.

In a sixth possible implementation manner of the first aspect, the uplink transmission field is configured at the end of the first subframe.

In a seventh possible implementation manner of the first aspect, the radio frame further includes an uplink subframe, a downlink subframe, or an uplink subframe and a downlink subframe, and the first subframe and the uplink subframe or the downlink subframe are configured at alternately.

In an eighth possible implementation manner of the first aspect, the radio frame further includes a guard period, the guard period is configured between the downlink transmission field and the uplink transmission field, and duration of a guard period is less than or equal to duration of the first subframe.

In a ninth possible implementation manner of the first aspect, a configuration parameter of the first subframe includes one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period.

With reference to the ninth possible implementation manner of the first aspect, in a tenth possible implementation manner of the first aspect, the configuration parameter of the first subframe is configured according to physical MAC layer signaling or radio resource control RRC layer signaling.

According to a second aspect, an implementation manner of the present disclosure discloses another radio frame transmission method, including:

receiving a radio frame, where the radio frame includes at least one first subframe, the at least one first subframe includes a downlink transmission field, a guard period, and an uplink transmission field, the downlink transmission field is used to carry a downlink signal, the uplink transmission field is used to carry an uplink signal, the guard period is used to extend duration in which a receive end is switched from the downlink transmission field to the uplink transmission field, the downlink transmission field includes N_{DL} symbols, the uplink transmission field includes N_{UL} symbols, N_{DL} and N_{UL} are integers greater than or equal to 0 and are not 0 at the same time, and a sum of N_{DL} and N_{UL} is less than or equal to a quantity of all symbols included in the first subframe; and

transmitting a downlink signal according to the downlink transmission field and transmitting an uplink signal according to the uplink transmission field.

In a first possible implementation manner of the second aspect, the downlink signal includes one or more of a downlink control signal, a downlink data signal, or a downlink reference signal.

In a second possible implementation manner of the second aspect, the uplink signal includes one or more of an uplink control signal, an uplink data signal, or an uplink reference signal.

In a third possible implementation manner of the second aspect, the uplink signal is an acknowledgment character ACK/NACK or an uplink scheduling request.

With reference to the third possible implementation manner of the second aspect, in a fourth possible implementation manner of the second aspect, the acknowledgment character ACK/NACK is used to acknowledge data of a frame prior to the radio frame.

With reference to the third possible implementation manner of the second aspect, in a fifth possible implementation manner of the second aspect, the acknowledgment character ACK/NACK is used to acknowledge data of the fourth forward subframe of the first subframe.

In a sixth possible implementation manner of the second aspect, the uplink transmission field is configured at the end of the first subframe.

In a seventh possible implementation manner of the second aspect, the radio frame further includes an uplink subframe, a downlink subframe, or an uplink subframe and a downlink subframe, and the first subframe and the uplink subframe or the downlink subframe are configured alternately.

In an eighth possible implementation manner of the second aspect, the radio frame further includes a guard period, the guard period is configured between the downlink transmission field and the uplink transmission field, and duration of a guard period is less than or equal to duration of the first subframe.

In a ninth possible implementation manner of the second aspect, a configuration parameter of the first subframe includes one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period.

With reference to the ninth possible implementation manner of the second aspect, in a tenth possible implementation manner of the second aspect, the configuration parameter of the first subframe is configured according to physical MAC layer signaling or radio resource control RRC layer signaling.

According to a third aspect, an implementation manner of the present disclosure puts forward a radio frame transmission apparatus, including:

a processing module, configured to generate a radio frame, where the radio frame includes at least one first subframe, the at least one first subframe includes a downlink transmission field, a guard period, and an uplink transmission field, the downlink transmission field is used to carry a downlink signal, the uplink transmission field is used to carry an uplink signal, the guard period is used to extend duration in which a receive end is switched from the downlink transmission field to the uplink transmission field, the downlink transmission field includes N_{DL} symbols, the uplink transmission field includes N_{UL} symbols, N_{DL} and N_{UL} are integers greater than or equal to 0 and are not 0 at the same time, and a sum of N_{DL} and N_{UL} is less than or equal to a quantity of all symbols included in the first subframe; and

a first sending module, configured to send the radio frame to the receive end, so that the receive end transmits a downlink signal according to the downlink transmission field and transmits an uplink signal according to the uplink transmission field.

In a first possible implementation manner of the third aspect, the downlink signal includes one or more of a downlink control signal, a downlink data signal, or a downlink reference signal.

In a second possible implementation manner of the third aspect, the uplink signal includes one or more of an uplink control signal, an uplink data signal, or an uplink reference signal.

In a third possible implementation manner of the third aspect, the uplink signal is an acknowledgment character ACK/NACK or an uplink scheduling request.

With reference to the third possible implementation manner of the third aspect, in a fourth possible implementation manner of the third aspect, the acknowledgment character ACK/NACK is used to acknowledge data of a frame prior to the radio frame.

With reference to the third possible implementation manner of the third aspect, in a fifth possible implementation manner of the third aspect, the acknowledgment character ACK/NACK is used to acknowledge data of the fourth forward subframe of the first subframe.

In a sixth possible implementation manner of the third aspect, the uplink transmission field is configured at the end of the first subframe.

In a seventh possible implementation manner of the third aspect, the radio frame further includes an uplink subframe, a downlink subframe, or an uplink subframe and a downlink subframe, and the first subframe and the uplink subframe or the downlink subframe are configured alternately.

In an eighth possible implementation manner of the third aspect, the radio frame further includes a guard period, the guard period is configured between the downlink transmission field and the uplink transmission field, and duration of a guard period is less than or equal to duration of the first subframe.

In a ninth possible implementation manner of the third aspect, a configuration parameter of the first subframe includes one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period.

With reference to the ninth possible implementation manner of the third aspect, in a tenth possible implementation manner of the third aspect, the configuration parameter of the first subframe is configured according to physical MAC layer signaling or radio resource control RRC layer signaling.

According to a fourth aspect, an implementation manner of the present disclosure discloses a radio frame transmission apparatus, including:

a receiving module, configured to receive a radio frame, where the radio frame includes at least one first subframe, the at least one first subframe includes a downlink transmission field, a guard period, and an uplink transmission field, the downlink transmission field is used to carry a downlink signal, the uplink transmission field is used to carry an uplink signal, the guard period is used to extend duration in which a receive end is switched from the downlink transmission field to the uplink transmission field, the downlink transmission field includes N_{DL} symbols, the uplink transmission field includes N_{UL} symbols, N_{DL} and N_{UL} are integers greater than or equal to 0 and are not 0 at the same time, and a sum of N_{DL} and N_{UL} is less than or equal to a quantity of all symbols included in the first subframe; and

a processing module, configured to transmit a downlink signal according to the downlink transmission field and transmit an uplink signal according to the uplink transmission field.

In a first possible implementation manner of the fourth aspect, the downlink signal includes one or more of a downlink control signal, a downlink data signal, or a downlink reference signal.

In a second possible implementation manner of the fourth aspect, the uplink signal includes one or more of an uplink control signal, an uplink data signal, or an uplink reference signal.

In a third possible implementation manner of the fourth aspect, the uplink signal is an acknowledgment character ACK/NACK or an uplink scheduling request.

With reference to the third possible implementation manner of the fourth aspect, in a fourth possible implementation manner of the fourth aspect, the acknowledgment character ACK/NACK is used to acknowledge data of a frame prior to the radio frame.

With reference to the third possible implementation manner of the fourth aspect, in a fifth possible implementation manner of the fourth aspect, the acknowledgment character ACK/NACK is used to acknowledge data of the fourth forward subframe of the first subframe.

In a sixth possible implementation manner of the fourth aspect, the uplink transmission field is configured at the end of the first subframe.

In a seventh possible implementation manner of the fourth aspect, the radio frame further includes an uplink subframe, a downlink subframe, or an uplink subframe and a downlink subframe, and the first subframe and the uplink subframe or the downlink subframe are configured alternately.

In an eighth possible implementation manner of the fourth aspect, the radio frame further includes a guard period, the guard period is configured between the downlink transmission field and the uplink transmission field, and duration of a guard period is less than or equal to duration of the first subframe.

In a ninth possible implementation manner of the fourth aspect, a configuration parameter of the first subframe includes one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period.

With reference to the ninth possible implementation manner of the fourth aspect, in a tenth possible implementation manner of the fourth aspect, the configuration parameter of the first subframe is configured according to physical MAC layer signaling or radio resource control RRC layer signaling.

In the radio frame transmission method that is put forward in the implementation manners of the present disclosure, an uplink transmission field that is used to transmit an uplink signal is inserted into a subframe. Even though a radio frame includes a relatively small quantity of uplink subframes, the uplink signal may be fed back in a timely manner by using the uplink transmission field, thereby reducing a system delay and improving communication efficiency.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show some embodiments of the present disclosure, and a person of ordinary skill in the art may still derive other drawings from these accompanying drawings without creative efforts.

FIG. 1 is a schematic flowchart of a radio frame transmission method according to an implementation manner of the present disclosure;

FIG. 2 is a schematic structural diagram of a radio frame according to an implementation manner of the present disclosure;

FIG. 3 is a schematic structural diagram of a first subframe according to an implementation manner of the present disclosure;

FIG. 4 is a schematic structural diagram of a first subframe according to another implementation manner of the present disclosure;

FIG. 5 is a schematic structural diagram of a first subframe according to another implementation manner of the present disclosure;

FIG. 6 is a schematic structural diagram of a first subframe according to another implementation manner of the present disclosure;

FIG. 7 is a schematic structural diagram of a radio frame transmission apparatus according to an implementation manner of the present disclosure;

FIG. 8 is a schematic structural diagram of a radio frame transmission apparatus according to another implementation manner of the present disclosure; and

FIG. 9 is a schematic structural diagram of a radio frame according to another implementation manner of the present disclosure.

### DETAILED DESCRIPTION

To make the objectives, technical solutions, and advantages of the embodiments of the present disclosure clearer, the following clearly and describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

A Massive Multiple-Input Multiple-Output (Massive MIMO) technology is considered as an important technology in the 5G system. The massive multiple-input multiple-output technology improves spectral efficiency by using a spatial multiplexing technology, but is highly dependent on accuracy of channel information between a transmit end and a receive end. In a frequency division duplex (FDD) mode, an uplink and a downlink are in different frequency bands, and the channel information between the transmit end and the receive end is generally obtained according to a feedback from the receive end. In a time division duplex (TDD) mode, an uplink and a downlink are distributed in different timeslots of a same frequency band. Approximation processing may be performed on an uplink channel and a downlink channel between the transmit end and the receive end by using channel reciprocity, so as to obtain the channel information. However, due to a time-varying characteristic of a channel, the transmit end has difficulty in obtaining instantaneous channel information. Particularly, with some configurations, there is a great difference between a quantity of uplink subframes and a quantity of downlink subframes, it is difficult to feed back uplink data in a timely manner, and the channel information between the transmit end and the receive end is greatly delayed. Consequently, performance of Massive MIMO is greatly affected, and it is difficult to satisfy the requirement of the 5G system for a short delay.

A typical radio frame structure at least includes one or more uplink subframes and one or more downlink subframes. The downlink subframe is used to carry a downlink signal. The downlink control signal includes one or more of a downlink control signal, a downlink data signal, or a downlink reference signal. The uplink subframe is used to carry one or more of an uplink control signal, an uplink data signal, or an uplink reference signal, for example, a hybrid automatic repeat request (HARD) acknowledgment (ACK)/NACK feedback or uplink scheduling request (SR) signaling. For example, a receive end decodes a downlink control signal or data after receiving a downlink subframe, and feeds back, in a subsequent uplink subframe, HARQ-ACK/NACK information corresponding to the downlink control signal or the data.

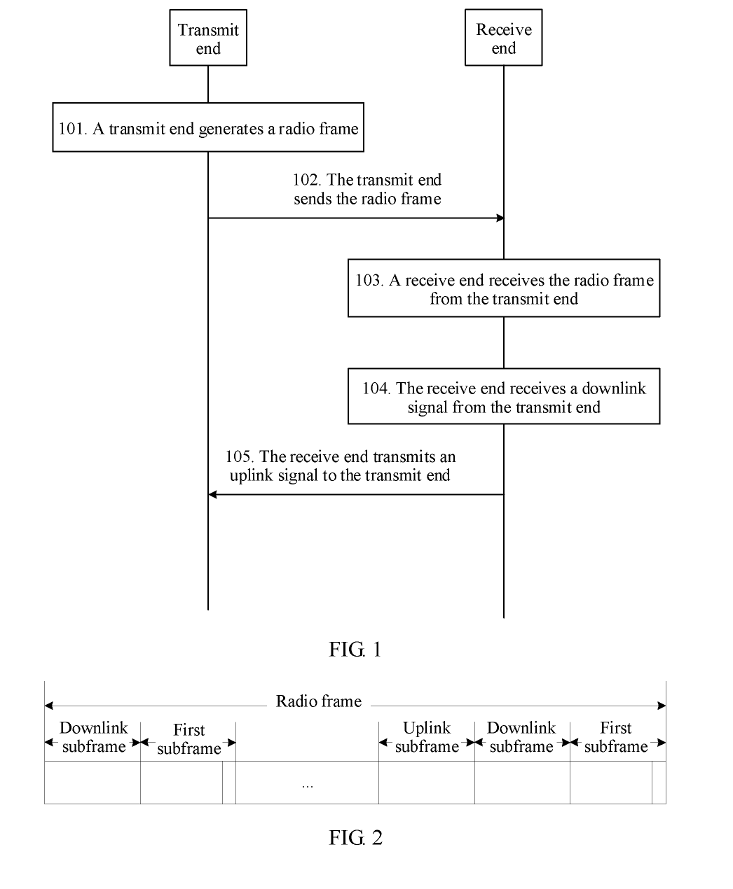

An implementation manner of the present disclosure provides a radio frame transmission method. As shown in FIG. 1, an implementation process of the radio frame transmission method includes the following steps.

101. A transmit end generates a radio frame.

The radio frame includes at least one first subframe. Also referring to FIG. 2, the first subframe includes a downlink transmission field and an uplink transmission field. The downlink transmission field is used to carry a downlink signal, and the uplink transmission field is used to carry an uplink signal. Optionally, the uplink transmission field is configured at the end of the first subframe.

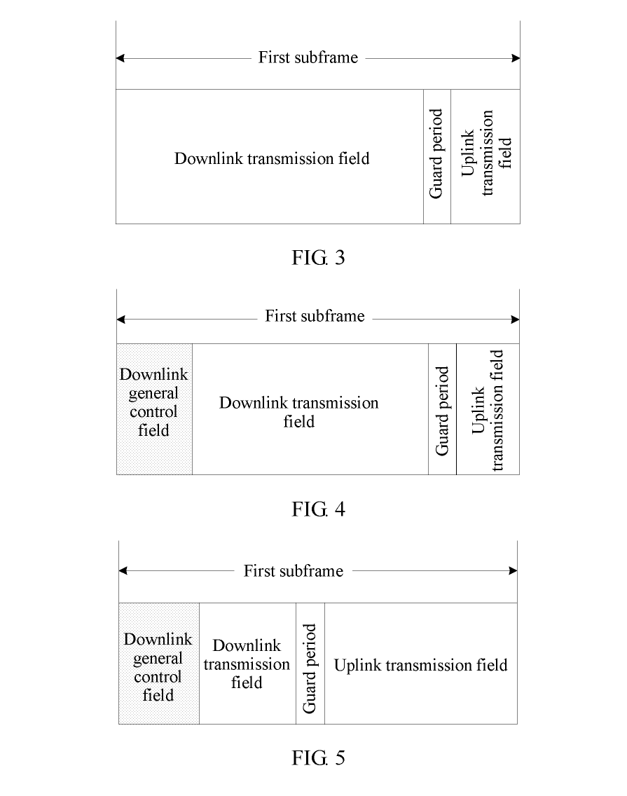

Optionally, referring to FIG. 3, the first subframe further includes a guard period. The guard period is configured between the downlink transmission field and the uplink transmission field, and duration of a guard period is less than or equal to duration of the first subframe. Specifically, the guard period includes N_{GP} symbols. N_{GP} is a positive integer that is greater than 0 but is less than a total symbols quantity of the first subframe. The guard period is used to implement a switchover from downlink transmission to uplink transmission. Alternatively, the guard period is used to extend duration in which a receive end is switched from downlink transmission to uplink transmission, so as to compensate for a delay in downlink transmission and a switching interval between uplink transmission and downlink transmission. By using a structure of the first subfram shown in FIG. 3 as an example, the following further describes the radio frame transmission method provided in this implementation manner of the present disclosure. It should be noted that the first subframe may not include the guard period, but includes only the downlink transmission field and the uplink transmission field.

Specifically, the uplink signal carried in the uplink transmission field may be one or more of an uplink control signal, an uplink data signal, or an uplink reference signal, for example, an acknowledgment (ACK)/NACK feedback or an uplink scheduling request (SR). The downlink signal carried in the downlink transmission field may be one or more of a downlink control signal, a downlink data signal, or a downlink reference signal.

The downlink transmission field includes N_{DL} symbols. The uplink transmission field includes N_{UL} symbols. N_{DL} and N_{UL} are integers greater than or equal to 0 and are not 0 at the same time. A sum of N_{DL} and N_{UL} is less than or equal to a quantity of all symbols included in the first subframe.

For example, when N_{DL}>N_{UL}, a structure of the first subframe is shown in FIG. 4, and a length of the downlink transmission field is greater than a length of the uplink transmission field. In the first subframe, the downlink transmission field is used to carry a downlink signal, and the uplink transmission field is used to carry an uplink control signal, for example, an HARQ ACK/NACK feedback or uplink scheduling request (SR) signaling. In this way, even though an uplink-subframe configuration is extremely small, an HARQ ACK/NACK feedback corresponding to downlink data transmission and an uplink scheduling request (SR) initiated by a user may be sent to a base station by using the uplink transmission field, so as to reduce uplink feedback time and user wakeup time. In addition, an uplink reference signal may also be mapped to the uplink transmission field, and is used to estimate channel information in the uplink transmission field, so as to demodulate the uplink control signal carried in the uplink transmission field. Due to channel reciprocity, instantaneous downlink channel information may be obtained by detecting the uplink reference signal, so that a Massive MIMO technology can be applied.

For example, when N_{D}L≥N_{DL}, a structure of the first subframe is shown in FIG. 5. The first subframe is mainly used to serve an uplink, and the uplink transmission field is used to carry at least one of an uplink data signal or an uplink control signal, and an uplink reference signal. The downlink transmission field in the first subframe may carry a downlink reference signal, a downlink control signal such as a downlink scheduling instruction for providing an in-time signaling indication for uplink data transmission, and the like.

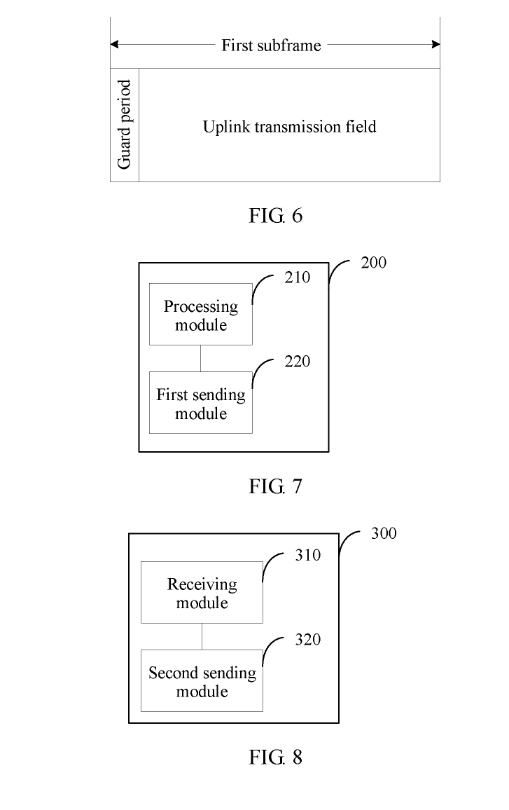

For example, when N_{DL}=0, a structure of the first subframe is shown in FIG. 6. The first subframe is used to serve an uplink. Although the first subframe includes no downlink transmission field, a guard period is still inserted at the beginning of the first subframe to adapt a scenario in which a subframe prior to the first subframe includes no uplink transmission field, so as to compensate for a downlink transmission delay and to provide a switching interval between uplink power and downlink power.

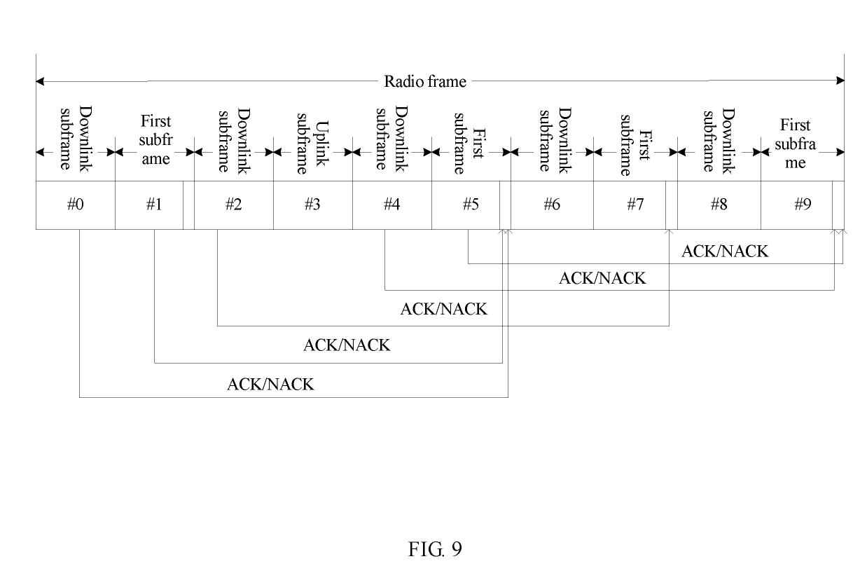

For example, a configuration parameter of the first subframe includes one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period. The configuration manner of the first subframe specifically means that the first subframe may be configured in a frame generated by the transmit end at regular intervals. For example, a first subframe is configured every N transmission time intervals (TTIs), and N is a positive integer greater than 1. Alternatively, as shown in FIG. 9, a first subframe is configured after each downlink subframe. The configuration parameter of the first subframe is configured according to physical MAC layer signaling or radio resource control RRC layer signaling, or may be preset.

102. The transmit end sends the radio frame to a receive end.

103. The receive end receives the radio frame from the transmit end.

104. The receive end transmits a downlink signal according to a downlink transmission field in the radio frame. Specifically, the receive end receives and decodes the downlink signal according to the downlink transmission field, so as to obtain a downlink control signal or a downlink data signal.

105. The receive end transmits an uplink signal according to an uplink transmission field in the radio frame. Specifically, the receive end feeds back an acknowledgement character ACK/NACK according to the downlink control signal. The acknowledgement character ACK/NACK is sent to the transmit end by using the uplink transmission field. Alternatively, the receive end sends uplink scheduling request signaling to the transmit end by using the uplink transmission field.

In the radio frame transmission method that is put forward in this implementation manner of the present disclosure, an uplink transmission field that is used to transmit an uplink signal is inserted into a subframe. Even though a radio frame includes a relatively small quantity of uplink subframes, the uplink signal may be fed back in a timely manner by using the uplink transmission field, thereby reducing a system delay and improving communication efficiency.

As shown in FIG. 7, an implementation manner of the present disclosure further provides a radio frame transmission apparatus 200 that is applied to a transmit end and is configured to perform steps 101 and 102 in the implementation manner shown in FIG. 1. The apparatus 200 includes a processing module 210 and a first sending module 220.

The processing module 210 is configured to generate a radio frame. The radio frame includes at least one subframe. The at least one first subframe includes a downlink transmission field, a guard period, and an uplink transmission field. The downlink transmission field is used to carry a downlink signal. The uplink transmission field is used to carry an uplink signal. The guard period is used to extend duration in which a receive end is switched from the downlink transmission field to the uplink transmission field.

Specifically, the uplink signal carried in the uplink transmission field may be one or more of an uplink control signal, an uplink data signal, or an uplink reference signal, for example, an acknowledgment (ACK)/NACK feedback or an uplink scheduling request (SR). The downlink signal carried in the downlink transmission field may be one or more of a downlink control signal, a downlink data signal, or a downlink reference signal.

The downlink transmission field includes N_{DL} symbols. The uplink transmission field includes N_{UL} symbols. N_{DL} and N_{UL} are integers greater than or equal to 0 and are not 0 at the same time. A sum of N_{DL} and N_{UL} is less than or equal to a quantity of all symbols included in the first subframe.

Optionally, the first subframe may be configured in a frame generated by the transmit end at regular intervals. For example, a first subframe is configured every N transmission time intervals (TTIs), and N is a positive integer greater than 1. Alternatively, as shown in FIG. 9, a first subframe is configured after each downlink subframe. The first subframe may be configured according to physical MAC layer signaling or radio resource control RRC layer signaling.

The first sending module 220 is configured to send the radio frame to a receive end, so that the receive end transmits a downlink signal according to the downlink transmission field and transmits an uplink signal according to the uplink transmission field.

As shown in FIG. 8, an implementation manner of the present disclosure further provides a frame transmission apparatus 300 that is applied to a receive end and is configured to perform steps 103 and 104 in the implementation manner shown in FIG. 1. The apparatus 300 includes a receiving module 310 and a second sending module 320.

The receiving module 310 is configured to receive a radio frame. The radio frame includes at least one first subframe. The at least one first subframe includes a downlink transmission field, a guard period, and an uplink transmission field. The downlink transmission field is used to carry a downlink signal. The uplink transmission field is used to carry an uplink signal. The guard period is used to extend duration in which the receive end is switched from the downlink transmission field to the uplink transmission field.

The downlink transmission field includes NDL symbols. The uplink transmission field includes NUL symbols. NDL and NUL are integers greater than or equal to 0 and are not 0 at the same time. A sum of NDL and NUL is less than or equal to a quantity of all symbols included in the first subframe.

The receiving module 310 is further configured to transmit a downlink signal according to the downlink transmission field. Specifically, the receive end receives and decodes the downlink signal according to the downlink transmission field, so as to obtain a downlink control signal or a downlink data signal.

The second sending module 320 is configured to transmit an uplink signal according to the uplink transmission field. Specifically, the second sending module 320 is configured to feed back an acknowledgement character ACK/NACK according to the downlink control signal. The acknowledgement character ACK/NACK is sent to a transmit end by using the uplink transmission field. Alternatively, the second sending module 320 is configured to send uplink scheduling request signaling to a transmit end by using the uplink transmission field.

Referring to FIG. 9, a frame transmission method in the present disclosure is further described by using an example that a subframe is configured every two TTIs. A frame structure shown in FIG. 9 includes a downlink subframe #0, a first subframe #1, a downlink subframe #2, an uplink subframe #3, a downlink subframe #4, a first subframe #5, a downlink subframe #6, a first subframe #7, a downlink subframe #8, and a first subframe #9.

The downlink subframe #2 is followed by the uplink subframe #3, and uplink control signaling or an uplink reference symbol may be transmitted by using the uplink subframe #3. Therefore, a first subframe that includes an uplink transmission field is not configured at a location of the uplink subframe #3.

After receiving a downlink signal in the downlink subframe #0 and the first subframe #1 and decoding the downlink signal, a receive end feeds back a corresponding HARQ ACK/NACK in an uplink transmission field of the first subframe #5. After receiving a downlink signal in the downlink subframe #2 and decoding the downlink signal, the receive end feeds back a corresponding HARQ ACK/NACK in an uplink transmission field of the first subframe #7. After receiving a downlink signal in the downlink subframe #4 and the first subframe #5 and decoding the downlink signal, the receive end feeds back a corresponding HARQ ACK/NACK in the first subframe #9. With this configuration, a maximum quantity of parallel HARQ processes is only 5, so that a demand for a register circuit is reduced.

An uplink transmission field is inserted into a subframe. Even though an uplink-subframe configuration is relatively small, an HARQ ACK/NACK corresponding to a downlink signal and an uplink scheduling request may be fed back by using the uplink transmission field, thereby reducing a system delay and improving communication efficiency.

Based on the descriptions of the implementation manners, a person skilled in the art may clearly understand that the present disclosure may be implemented by software in addition to necessary general hardware. Based on such an understanding, all or some of the steps of the technical solutions of the present disclosure may be implemented by a program instructing relevant hardware. The program may be stored in a computer readable storage medium. When the program runs, the steps of the method embodiment are performed. The storage medium may be a ROM/RAM, a magnetic disk, an optical disc, or the like.

In addition, modules in the implementation manners of the present disclosure may be integrated into one processing module, or each of the modules may exist alone physically, or two or more modules are integrated into one larger module. The integrated module may be implemented in a form of hardware, or may be implemented in a form of a software functional module. Steps of the methods disclosed with reference to the implementation manners of the present disclosure may be directly performed by using a hardware encoding processor, or may be performed by using a combination of hardware in the encoding processor and a software module. The software module may be located in a storage medium, such as a random access memory, a flash memory, a read-only memory, a programmable read-only memory, an electrically-erasable programmable memory, or a register.

When the module or the integrated module is implemented in the form of hardware, the module or the integrated module may be an integrated circuit (IC), an application-specific integrated circuit (ASIC), a field-programmable gate array (FPGA), or the like, or may be integrated into a baseband processor or a general purpose processor.

If the module or the integrated module is implemented in the form of a software functional module and sold or used as an independent product, the module or the integrated module may be stored in a computer-readable storage medium. Based on such an understanding, the technical solutions of the present disclosure essentially, or all or some of the technical solutions may be implemented in a form of a software product. The software product is stored in a storage medium, and includes several instructions for instructing a device (which may be a personal computer, a server, or a network device such as a base station, an access point, and a station) with a computation function to perform all or some of the steps of the methods described in the implementation manners of the present disclosure. The storage medium includes: any medium that can store program code, such as a USB flash drive, a removable hard disk, a read-only memory (ROM), a random access memory (RAM), a magnetic disk, or an optical disc.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

The descriptions are only specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A radio frame transmission method, comprising:
generating a radio frame, wherein the radio frame comprises at least one first subframe, the at least one first subframe comprises a downlink transmission field and an uplink transmission field, the downlink transmission field is used to carry a downlink signal, the uplink transmission field is used to carry an uplink signal, the downlink transmission field comprises N_{DL} symbols, the uplink transmission field comprises N_{UL} symbols, N_{DL} and N_{UL} are integers greater than or equal to 0 and are not 0 at the same time, and a sum of N_{DL} and N_{UL} is less than or equal to a quantity of all symbols comprised in the first subframe; and
sending the radio frame to a receive end, so that the receive end transmits a downlink signal according to the downlink transmission field and transmits an uplink signal according to the uplink transmission field.

2. The method according to claim 1, wherein the radio frame further comprises a guard period, the guard period is configured between the downlink transmission field and the uplink transmission field, and duration of the guard period is less than or equal to duration of the first subframe.

3. The method according to claim 1, wherein the downlink signal comprises one or more of a downlink control signal, a downlink data signal, or a downlink reference signal.

4. The method according to claim 1, wherein the uplink signal comprises one or more of an uplink control signal, an uplink data signal, or an uplink reference signal.

5. The method according to claim 1, wherein the uplink signal is an acknowledgment (ACK)/NACK or an uplink scheduling request.

6. The method according to claim 5, wherein the acknowledgment character ACK/NACK is used to acknowledge data of a frame prior to the radio frame.

7. The method according to claim 5, wherein the acknowledgment character ACK/NACK is used to acknowledge data of the fourth forward subframe of the first subframe.

8. The method according to claim 1, wherein the uplink transmission field is configured at the end of the first subframe.

9. The method according to claim 1, wherein the radio frame further comprises an uplink subframe, a downlink subframe, or an uplink subframe and a downlink subframe, and the first subframe and the uplink subframe or the downlink subframe are configured alternately.

10. The method according to claim 1, wherein a configuration parameter of the first subframe comprises one or more of a configuration manner of the first subframe, a start location and a period of the first subframe, a quantity of first subframes in the radio frame, a configuration between the first subframe and another subframe, a value of N_{DL} and a value of N_{UL}, or duration of a guard period.

11. The method according to claim 10, wherein the configuration parameter of the first subframe is configured according to physical MAC layer signaling or radio resource control RRC layer signaling.

12. A radio frame transmission method, comprising:
receiving a radio frame, wherein the radio frame comprises at least one first subframe, the at least one first subframe comprises a downlink transmission field and an uplink transmission field, the downlink transmission field is used to carry a downlink signal, the uplink transmission field is used to carry an uplink signal, the downlink transmission field comprises N_{DL} symbols, the uplink transmission field comprises N_{UL} symbols, N_{DL} and N_{UL} are integers greater than or equal to 0 and are not 0 at the same time, and a sum of N_{DL} and N_{UL} is less than or equal to a quantity of all symbols comprised in the first subframe; and
transmitting a downlink signal according to the downlink transmission field and transmitting an uplink signal according to the uplink transmission field.

13. The method according to claim 12, wherein the radio frame further comprises a guard period, the guard period is configured between the downlink transmission field and the uplink transmission field, and duration of the guard period is less than or equal to duration of the first subframe.

14. The method according to claim 12, wherein the uplink signal is an acknowledgment (ACK) or a NACK, the ACK or the NACK is used to acknowledge data of the fourth forward subframe of the first subframe.

15. The method according to claim 12, wherein the radio frame further comprises an uplink subframe, a downlink subframe, or an uplink subframe and a downlink subframe, and the first subframe and the uplink subframe or the downlink subframe are configured alternately.

16. A radio frame transmission apparatus, comprising:
a non-transitory memory storage comprising instructions; and
one or more processors in communication with the memory, wherein the one or more processors execute the instructions to:
generate a radio frame, wherein the radio frame comprises at least one first subframe, the at least one first subframe comprises a downlink transmission field and an uplink transmission field, the downlink transmission field is used to carry a downlink signal, the uplink transmission field is used to carry an uplink signal, the downlink transmission field comprises N_{DL} symbols, the uplink transmission field comprises N_{UL} symbols, N_{DL} and N_{UL} are integers greater than or equal to 0 and are not 0 at the same time, and a sum of N_{DL} and N_{UL} is less than or equal to a quantity of all symbols comprised in the first subframe; and
send the radio frame to a receive end, so that the receive end transmits a downlink signal according to the downlink transmission field and transmits an uplink signal according to the uplink transmission field.

17. The apparatus according to claim 16, wherein the radio frame further comprises a guard period, the guard period is configured between the downlink transmission field and the uplink transmission field, and duration of the guard period is less than or equal to duration of the first subframe.

18. The apparatus according to claim 16, wherein a configuration parameter of the first subframe comprises one or more of a configuration manner of the first subframe, a start location and a period of the first subframe, a quantity of the first subframes in the radio frame, a configuration between the first subframe and another subframe, a value of N_{DL} and a value of N_{UL}, or duration of a guard period.
